(19) United States
(12) Patent Application Publication
(10) Pub. No.: US 2026/0200057 A1
(43) Pub. Date: Jul. 16, 2026

(54) LOCKING/UNLOCKING STRUCTURE FOR A LOCKING BLOCK ON A NAILING GUN

(71) Applicant: Zhejiang Rongpeng Air Tools Co., Ltd., Taizhou (CN)

(72) Inventors: Xiaorong Li, Taizhou (CN); Xiaopeng Li, Taizhou (CN)

(21) Appl. No.: 19/023,304

(22) Filed: Jan. 16, 2025

(51) Int. Cl. B25C 1/04; B25C 1/06

(52) U.S. Cl. CPC B25C 1/047; B25C 1/06

(57) ABSTRACT

An improved locking/unlocking structure for a nailing gun’s locking block includes a power box, a striking pin, and multiple teeth formed on one side of the pin, with a catch slot on the other side. A fixed pivot shaft on the power box supports a rotatable locking block that engages or disengages the slot. A tension spring biases the block toward a locked mode. A drive motor beneath the box drives a cam connected via a synchronization shaft, a support seat, and a lever, restricting the block’s rotation. Elevating or lowering the lever locks or unlocks the block. After 150,000 locking/unlocking cycles, minimal wear is observed, maintaining the gun’s performance and durability. This design significantly improves reliability compared to conventional mechanisms, as repeated operation does not compromise essential functionality or reduce the efficiency of nailing operations. The structure is easily adaptable to various nailing gun models and environments.

### FIELD OF THE INVENTION

The present invention relates to a locking/unlocking structure for a locking block of a nailing gun.

### BACKGROUND OF THE INVENTION

A nailing gun is a tool used for driving nails. One known single-cylinder type nailing gun is driven by an electric motor whose output end is connected to a lifting wheel through a speed reducer. The lifting wheel is provided with multiple pins arranged circumferentially, which are adapted to engage with teeth formed on one side of a striking pin (also referred to as a driver blade). The rear end of the striking pin includes a piston-cylinder structure, and the striking pin and piston are fixedly connected. As the lifting wheel rotates, it drives the striking pin to move from a bottom dead center (BDC) to a top dead center (TDC), thereby generating high pressure inside the cylinder. On the opposite side of the striking pin, a bayonet-like catch (referred to herein as a “catch slot” or “bayonet slot”) is formed. A rotatable locking block can be driven to engage with or disengage from this catch slot, resulting in a locked state (where the striking pin is held at the TDC) or an unlocked state (where the striking pin is released under high pressure to drive a nail). The striking pin thus moves from its top stop position to its bottom stop position. Through the unidirectional rotation of the lifting wheel and the locking/unlocking action of the locking block, the striking pin can reciprocate between the top stop position and the bottom stop position to perform successive nailing actions.

Chinese Patent Publication No. CN114536278A discloses an example of a nailing gun in which the rotation of the locking block is achieved through the cooperation of a driving wheel, a locking ball, and a locking seat, thereby realizing the locking and unlocking function. The driving wheel is formed with a release groove, and the locking block is provided with a spherical recess. Fatigue testing shows that after approximately 30,000–50,000 cycles of locking and unlocking, noticeable wear appears on the driving wheel and the locking seat, adversely affecting the performance of the nailing gun. In the prior art, attempts have been made to use harder alloy materials for the driving wheel and locking block. However, due to the presence of the release groove and the spherical recess, machining of these components becomes more complicated, and further significant improvements in wear resistance through material selection alone have been difficult.

In view of the aforementioned challenges in the prior art, the present invention provides a new approach that aims to improve the durability of the locking block structure in a nailing gun.

### SUMMARY OF THE INVENTION

In order to address the deficiencies noted above, the present invention provides a locking/unlocking structure for a locking block on a nailing gun.

According to one aspect of the present invention, there is provided a locking/unlocking structure for a locking block on a nailing gun, comprising: a power box and a striking pin arranged above the power box so as to be movable relative thereto, wherein multiple teeth are formed on one side of the striking pin at regular intervals, and a catch slot is formed on the other side of the striking pin; a fixed pivot shaft installed on the power box at the side of the striking pin where the catch slot is located, wherein a rotatable locking block is mounted on the fixed pivot shaft; the locking block being arranged to engage in or disengage from the catch slot by rotating into or out of the catch slot, thereby locking or unlocking the striking pin; a tension spring (a “return spring”) provided on the power box, urging the locking block to return to a locked state; a drive motor arranged below the power box, wherein the drive motor’s output shaft is provided with a cam; and an intermediate transmission assembly, coupled to the cam, for limiting the rotation of the locking block.

More specifically, the intermediate transmission assembly includes a synchronization shaft, a support seat, and a lever. The synchronization shaft is rotatably disposed on the power box at a position laterally offset from the fixed pivot shaft. A swing arm is fixed to a lower end of the synchronization shaft and includes a torsion spring. The swing arm is connected in driving relation with the cam such that rotation of the cam causes the swing arm to swing and thereby drive the synchronization shaft to rotate. The upper end of the synchronization shaft is fixed with a synchronizing wheel, which has a first inclined surface formed on its upper face. The support seat is fixed at an upper part of the power box and has one end provided with a pivot shaft on which the lever is rotatably mounted. An end of the lever near the synchronizing wheel is formed with a second inclined surface matching the first inclined surface. The other end of the lever, away from the synchronizing wheel, is arranged with a spring.

In the locked state, the inner side surface of the lever’s end that is away from the synchronizing wheel abuts against an outer side surface of the locking block, thereby restricting rotation of the locking block.

In one embodiment, a lifting wheel is arranged on the side of the power box where the striking pin’s teeth are located. The lifting wheel includes multiple pins, which engage with the teeth on the striking pin, thus driving the striking pin from a bottom stop position toward a top stop position.

In another embodiment, a spring post is fixed to the locking block, and a tension-spring bracket is fixed to the power box. One end of the tension spring is attached to the tension-spring bracket, and the other end of the tension spring is attached to the spring post, thereby biasing the locking block toward the locked state.

In yet another embodiment, a guide pad is disposed on the fixed pivot shaft above the locking block. The guide pad is formed with a flat slot that matches a flat portion of the fixed pivot shaft. The upper part of the guide pad is secured with a locknut. A pressure plate is fixed to the power box via first and second bolts and is arranged above the striking pin in a perpendicular orientation to the striking pin. A bushing is fitted over the first bolt. The guide pad includes an integral guiding portion that is bent in a hook shape, and both inner side surfaces of the guiding portion bear closely against the bushing.

In another embodiment, a limit piece is arranged on the fixed pivot shaft between the guide pad and the locknut. The limit piece is formed integrally with a first limiting end and a second limiting end. After the limit piece is installed, the first limiting end is in contact with the first bolt, and the second limiting end restricts the position of the tension spring.

In a further embodiment, a bronze bushing is disposed between the synchronization shaft and the power box. The bronze bushing is fixed in the power box, and the synchronization shaft is rotatably arranged inside the bronze bushing.

In another embodiment, a balance pressure plate is fixed above the power box. The end of the lever close to the synchronizing wheel is guided within a guide slot formed in the balance pressure plate.

In yet another embodiment, in the locked state, the outer side surface of the lever’s end that is away from the synchronizing wheel abuts against a force-bearing surface on the support seat.

In another embodiment, the locking block is provided with a first limiting portion, and the support seat forms a second limiting portion, which cooperates with the first limiting portion to define the position of the locking block in the locked state.

Compared with the prior art, the present invention achieves the locking and unlocking of the locking block through the up-and-down pivoting motion of the lever. Laboratory testing indicates that, even after 150,000 cycles of locking and unlocking, the locking block exhibits only minimal wear, and the nailing gun maintains its excellent performance. Thus, durability is significantly enhanced.

### BRIEF DESCRIPTION OF THE DRAWINGS

FIG. 1 is a perspective view of one embodiment of the locking/unlocking structure for a locking block on a nailing gun in accordance with the present invention;

FIG. 2 is a schematic illustration showing the positional relationship between the striking pin and the lifting wheel;

FIG. 3 is a schematic illustration showing the locking block and its surrounding structure on the side of the striking pin;

FIG. 4 is an exploded view of the locking block portion on the side of the striking pin;

FIG. 5 is a schematic illustration of the intermediate transmission assembly;

FIG. 6 is a schematic illustration of the fixed pivot shaft;

FIG. 7 is a schematic illustration showing the interaction between the guide pad and the bushing;

FIG. 8 is a schematic illustration of the guide pad;

FIG. 9 is a schematic illustration of the limit piece;

FIG. 10 is a schematic illustration showing the locking block in a locked mode.

### DETAILED DESCRIPTION OF THE PREFERRED EMBODIMENTS

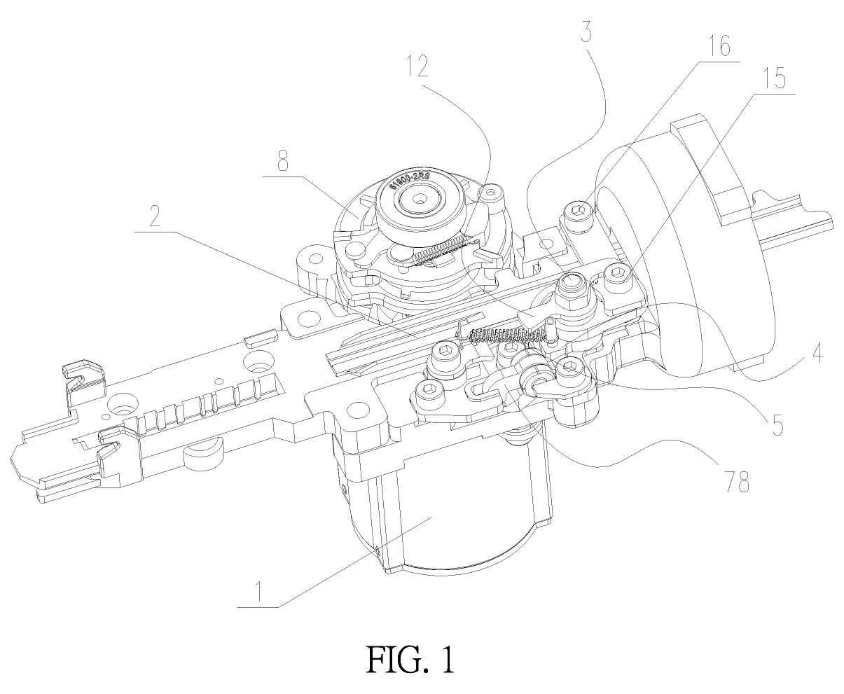

Referring to FIGS. 1, 2, and 3, one embodiment of the present invention provides a locking/unlocking structure for a locking block of a nailing gun. It includes a power box 1 and a striking pin 2 that is arranged above the power box 1 so as to be movable vertically. Multiple teeth 21 are formed at regular intervals on one side of the striking pin 2, and a catch slot 22 is formed on the other side of the striking pin 2. A fixed pivot shaft 3 is installed on the power box 1 at the side where the striking pin 2 has the catch slot 22. A rotatable locking block 4 is mounted on the fixed pivot shaft 3. By rotating the locking block 4 into or out of the catch slot 22, the striking pin 2 is locked or unlocked. A tension spring 5 is arranged on the power box 1 to urge the locking block 4 to return toward the locked mode. A drive motor (not shown) is arranged below the power box 1, and the motor’s output shaft is fitted with a cam 6. The cam 6 interacts with an intermediate transmission assembly 7 to limit rotation of the locking block 4.

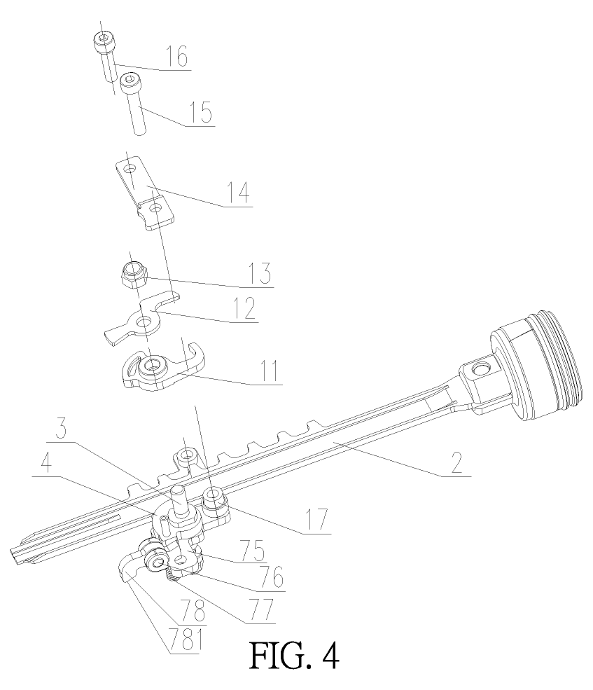

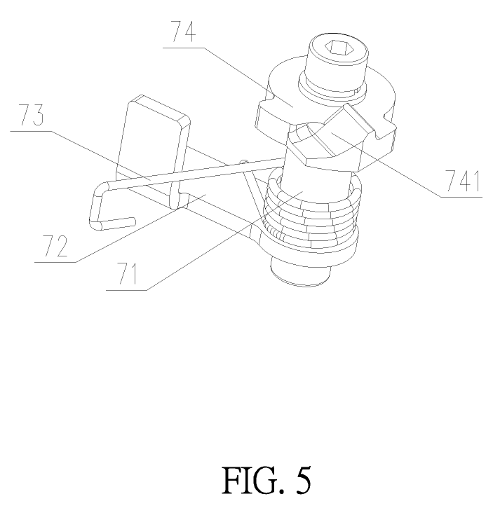

As shown in FIGS. 4 and 5, the intermediate transmission assembly 7 includes a synchronization shaft 71, a support seat 75, and a lever 78. The synchronization shaft 71 is rotatably disposed on the power box 1 on the same side as but offset from the fixed pivot shaft 3. A bronze bushing (not separately numbered) is provided between the power box 1 and the synchronization shaft 71 to reduce wear, and the bronze bushing is fixed in the power box 1. A swing arm 72 is fixed to the lower end of the synchronization shaft 71, and is provided with a torsion spring 73. The cam 6 drives the swing arm 72 to swing, thereby driving the synchronization shaft 71 to rotate. The torsion spring 73 serves to restore the swing arm 72 to its initial position. The upper end of the synchronization shaft 71 is fixed with a synchronizing wheel 74, which has a first inclined surface 741 on its upper face. The support seat 75 is fixed at an upper portion of the power box 1 and has one end provided with a pivot shaft 76. The lever 78 is rotatably mounted on the pivot shaft 76. The lever 78 has a second inclined surface 781 formed on the end adjacent to the synchronizing wheel 74, which matches the first inclined surface 741. The opposite end of the lever 78 (i.e., the end farther from the synchronizing wheel 74) is arranged with a spring 77.

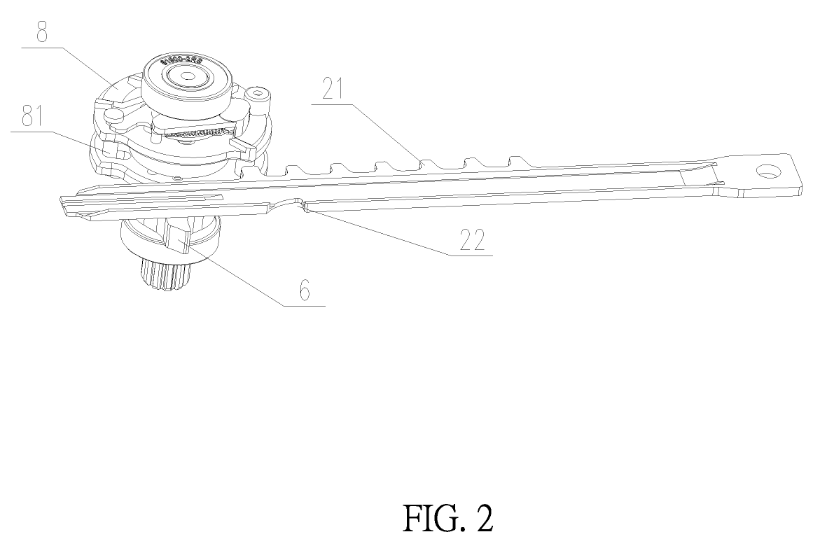

As shown in FIG. 2, a lifting wheel 8 is provided on the side of the power box 1 where the striking pin 2’s teeth 21 are located. Multiple pins 81 on the lifting wheel 8 engage the teeth 21 of the striking pin 2, thus driving the striking pin 2 from a bottom stop position to a top stop position.

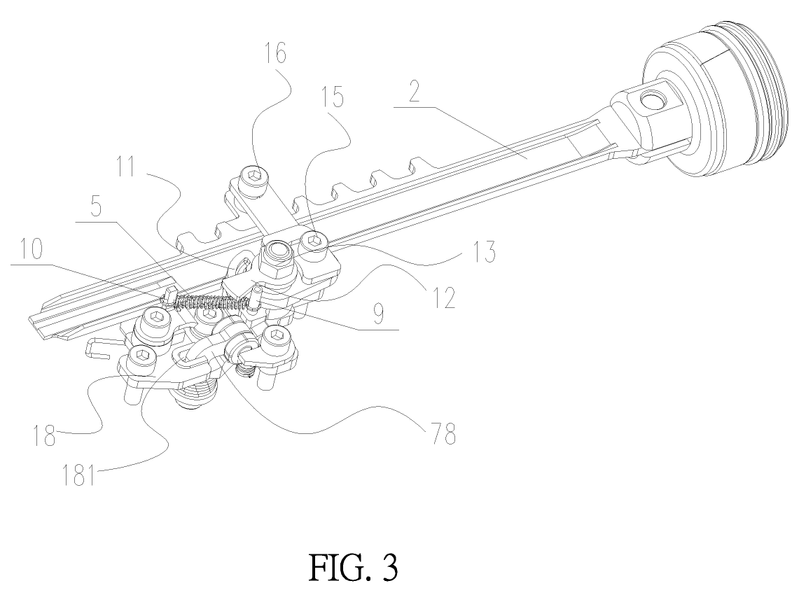

As shown in FIG. 3, a spring post 9 is fixed to the locking block 4, and a tension-spring bracket 10 is fixed to the power box 1. One end of the tension spring 5 is attached to the tension-spring bracket 10, and the other end is attached to the spring post 9, thereby biasing the locking block 4 toward the locked mode.

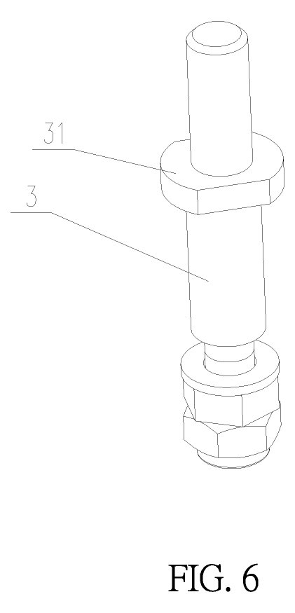

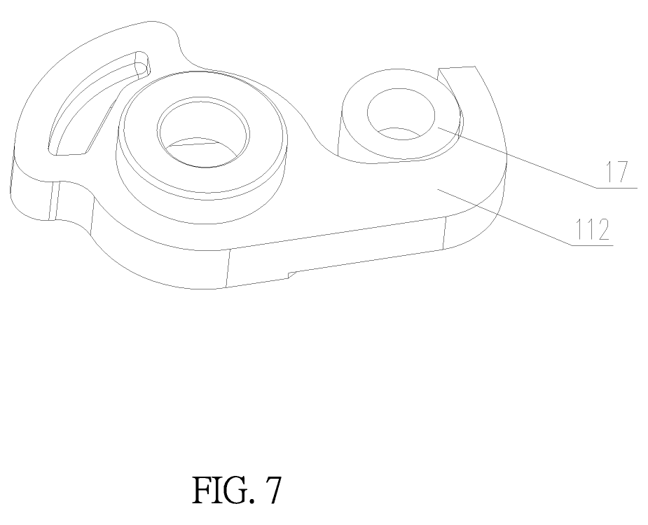

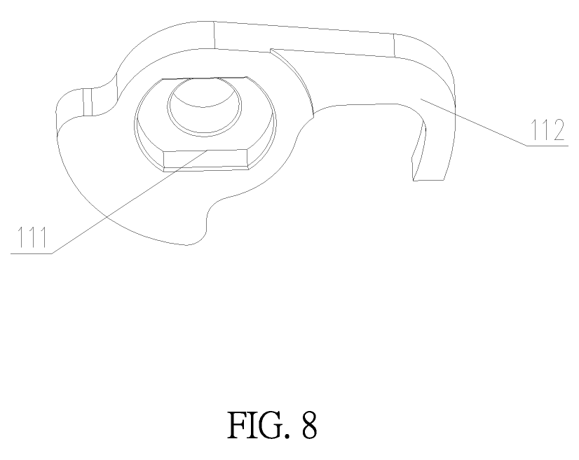

Referring to FIGS. 4, 6, and 8, the fixed pivot shaft 3 is also provided with a guide pad 11 that is located above the locking block 4. The guide pad 11 has a flat slot 111 corresponding to a flat portion 31 on the fixed pivot shaft 3, such that the two components rotate in unison. A locknut 13 is fastened to the upper portion of the guide pad 11. A pressure plate 14 is secured to the power box 1 by a first bolt 15 and a second bolt 16. This pressure plate 14 is disposed above the striking pin 2 and oriented perpendicular to it. A bushing 17 is fitted around the first bolt 15. The guide pad 11 has an integral guiding portion 112 formed in a curved, hook-like shape, and both inner side surfaces of the guiding portion 112 closely abut the bushing 17 (see FIG. 7). The engagement between the flat slot 111 of the guide pad 11 and the flat portion 31 of the fixed pivot shaft 3 ensures synchronous rotation. The bushing 17 limits rotation in the plane of the guide pad 11, preventing torsional deformation of the fixed pivot shaft 3, while the pressure plate 14 presses down on the guide pad 11, inhibiting bending deformation of the fixed pivot shaft 3. Consequently, impacts transmitted from the striking pin 2 to the fixed pivot shaft 3 are effectively mitigated, stabilizing the fixed pivot shaft 3.

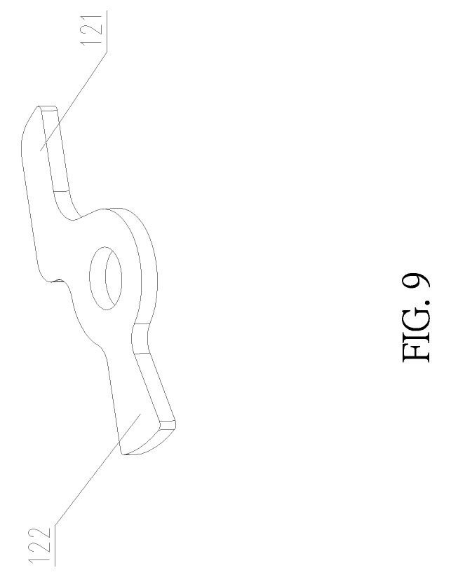

Referring to FIGS. 3 and 9, the fixed pivot shaft 3 is further provided with a limit piece 12 positioned between the guide pad 11 and the locknut 13. The limit piece 12 integrally includes a first limiting end 121 and a second limiting end 122. After the limit piece 12 is positioned and secured, the first limiting end 121 abuts the first bolt 15, and the second limiting end 122 limits the position of the tension spring 5.

As shown in FIG. 3, a balance pressure plate 18 is fixed above the power box 1, and the end of the lever 78 near the synchronizing wheel 74 is guided in a guide slot 181 of the balance pressure plate 18, thereby improving the stability of the lever 78.

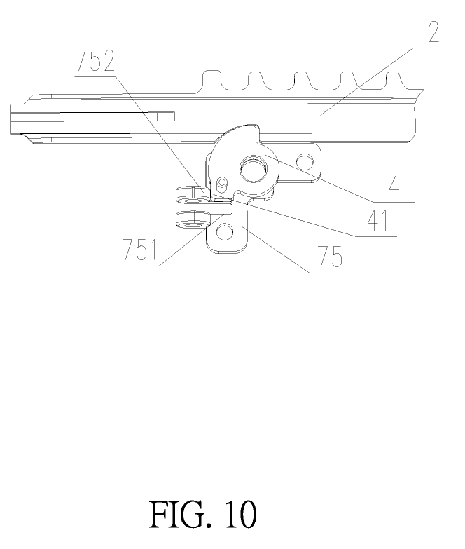

With reference to FIG. 4, in the locked mode, the inner side surface of the lever 78 at the end away from the synchronizing wheel 74 bears against an outer side surface of the locking block 4, thereby restricting rotation of the locking block 4. As shown in FIG. 10, the outer side surface of the lever 78 at the end away from the synchronizing wheel 74 abuts against a force-bearing surface 751 on the support seat 75, enabling the load on the locking block 4 to be indirectly transferred to the support seat 75 and reducing direct load on the lever 78.

As also shown in FIG. 10, the locking block 4 is provided with a first limiting portion 41, and the support seat 75 forms a second limiting portion 752. The second limiting portion 752 cooperates with the first limiting portion 41 to define the position of the locking block 4 in the locked mode, preventing over-rotation as the tension spring 5 returns the locking block 4 to its locked position.

By raising and lowering the lever 78, the locking and unlocking of the locking block 4 is achieved. Laboratory tests demonstrate that even after 150,000 cycles of locking and unlocking, wear on the locking block 4 remains minimal, and the nailing gun continues to function properly, indicating a significant improvement in durability.

For ease of understanding, operation of the invention is further described with reference to the drawings:

Locked State: Under the action of the torsion spring 73, the first inclined surface 741 on the synchronizing wheel 74 does not contact the second inclined surface 781 on the lever 78. The lever 78, under the urging of the spring 77, pivots upward at one end, causing that end to press against an outer side surface of the locking block 4. At this time, the locking block 4 is engaged in the catch slot 22 of the striking pin 2 (see FIGS. 4 and 10).

Unlocking: When the drive motor in the power box 1 rotates the cam 6, the cam 6 makes a quick, momentary contact with the swing arm 72, causing the swing arm 72 to swing slightly, which in turn drives the synchronization shaft 71 and the synchronizing wheel 74 to rotate through a certain angle (clockwise in FIG. 5). The first inclined surface 741 engages with the second inclined surface 781, lifting the lever 78 against the bias of the spring 77. Consequently, the end of the lever 78 near the locking block 4 pivots downward around the pivot shaft 76 and withdraws into the support seat 75, no longer restricting the locking block 4. High-pressure gas inside the cylinder forces the striking pin 2 to fire, causing the striking pin 2 to overcome the tension of the tension spring 5 and rotate the locking block 4 (counterclockwise in FIG. 4) out of engagement with the catch slot 22. The striking pin 2 is thus released from the locked position and moves from the top stop position to the bottom stop position, completing a nailing operation. With the locking block 4 rotated away from the catch slot 22, unlocking is achieved.

After one full rotation of the lifting wheel 8, the striking pin 2, which has completed its firing stroke, is brought back to the top stop position. At this time, under the urging of the tension spring 5, the locking block 4 rotates (clockwise in FIG. 4) again to re-engage with the catch slot 22 of the striking pin 2. Meanwhile, the torsion spring 73 restores the synchronizing wheel 74 to its original position, and the spring 77 restores the lever 78, causing the end of the lever 78 near the locking block 4 to pivot upward around the pivot shaft 76 and press against the locking block 4 once more, thereby reestablishing the locked state. When the lifting wheel 8 completes its rotation and stops, all pins 81 disengage from the teeth 21 of the striking pin 2.

The foregoing description merely illustrates a preferred embodiment of the present invention and should not be construed as limiting. Various modifications, equivalent substitutions, and improvements made within the spirit and principle of the present invention are intended to be encompassed within the scope of the appended claims once they are presented.

What is claimed is:

1. A locking/unlocking structure for a locking block of a nailing gun, comprising:
a power box (1);
a striking pin (2) disposed above the power box (1) so as to be movable relative thereto, the striking pin (2) having multiple teeth (21) formed at regular intervals on one side thereof, and a catch slot (22) formed on the other side thereof;
a fixed pivot shaft (3) installed on the power box (1) at the side of the striking pin (2) where the catch slot (22) is located;
a rotatable locking block (4) mounted on the fixed pivot shaft (3), the locking block (4) being configured to lock or unlock the striking pin (2) by rotating into or out of engagement with the catch slot (22); and
a tension spring (5) provided on the power box (1) for biasing the locking block (4) to return toward a locked mode;
wherein a drive motor is disposed below the power box (1), the output shaft of the drive motor is provided with a cam (6), and an intermediate transmission assembly (7) is employed to restrict rotation of the locking block (4); the intermediate transmission assembly (7) comprises:
a synchronization shaft (71), rotatably passing through the power box (1) and located to one side of the fixed pivot shaft (3);
a swing arm (72) fixed to a lower end of the synchronization shaft (71), the swing arm (72) being equipped with a torsion spring (73), wherein the swing arm (72) is drivingly connected to the cam (6) such that swinging motion of the swing arm (72) drives rotation of the synchronization shaft (71);
a synchronizing wheel (74) fixed to an upper end of the synchronization shaft (71), the synchronizing wheel (74) having a first inclined surface (741) formed on its upper surface;
a support seat (75) fixed to an upper portion of the power box (1), one end of the support seat (75) being provided with a pivot shaft (76); and
a lever (78) rotatably disposed on the pivot shaft (76), the lever (78) having, at an end adjacent to the synchronizing wheel (74), a second inclined surface (781) matching the first inclined surface (741), and further having, at an opposite end away from the synchronizing wheel (74), a spring (77);
wherein, in a locked mode, an inner side surface of the end of the lever (78) that is away from the synchronizing wheel (74) abuts against an outer side surface of the locking block (4), thereby restricting rotation of the locking block (4).

2. The locking/unlocking structure for a locking block of a nailing gun according to claim 1, wherein the power box (1) is provided, on the side of the striking pin (2) having the teeth (21), with a lifting wheel (8) that cooperates with the teeth (21) via multiple pins (81) to drive the striking pin (2) from a bottom stop position to a top stop position.

3. The locking/unlocking structure for a locking block of a nailing gun according to claim 2, wherein a spring post (9) is fixed on the locking block (4), and a tension-spring bracket (10) is fixed on the power box (1); one end of the tension spring (5) is attached to the tension-spring bracket (10), and the other end of the tension spring (5) is attached to the spring post (9), thereby biasing the locking block (4) to return toward the locked mode.

4. The locking/unlocking structure for a locking block of a nailing gun according to claim 3, wherein a guide pad (11) is further provided on the fixed pivot shaft (3) and is located above the locking block (4); the guide pad (11) includes a flat slot (111) that matches a flat portion (31) of the fixed pivot shaft (3), and an upper portion of the guide pad (11) is secured by a locknut (13); a pressure plate (14) is further secured to the power box (1) by a first bolt (15) and a second bolt (16), the pressure plate (14) being disposed above the striking pin (2) and oriented perpendicular thereto; a bushing (17) is fitted over the first bolt (15); the guide pad (11) has an integral guiding portion (112) bent into a hook shape, and both inner side surfaces of the guiding portion (112) are in close contact with the bushing (17).

5. The locking/unlocking structure for a locking block of a nailing gun according to claim 4, wherein a limit piece (12) is further provided on the fixed pivot shaft (3) between the guide pad (11) and the locknut (13); the limit piece (12) integrally includes a first limiting end (121) and a second limiting end (122); after the limit piece (12) is positioned, the first limiting end (121) abuts the first bolt (15), and the second limiting end (122) restricts the position of the tension spring (5).

6. The locking/unlocking structure for a locking block of a nailing gun according to claim 1, wherein a bronze bushing is arranged between the synchronization shaft (71) and the power box (1); the bronze bushing is fixed in the power box (1), and the synchronization shaft (71) is rotatably disposed within the bronze bushing.

7. The locking/unlocking structure for a locking block of a nailing gun according to claim 1, wherein a balance pressure plate (18) is further fixed above the power box (1), and an end of the lever (78) adjacent to the synchronizing wheel (74) is movably guided in a guide slot (181) of the balance pressure plate (18).

8. The locking/unlocking structure for a locking block of a nailing gun according to claim 1, wherein, in the locked mode, an outer side surface of the end of the lever (78) that is away from the synchronizing wheel (74) abuts against a force-bearing surface (751) of the support seat (75).

9. The locking/unlocking structure for a locking block of a nailing gun according to claim 1, wherein the locking block (4) further includes a first limiting portion (41), and the support seat (75) is formed with a second limiting portion (752); the second limiting portion (752) cooperates with the first limiting portion (41) to define the position of the locking block (4) in the locked mode.
